(19) United States
(12) Patent Application Publication
(10) Pub. No.: US 2026/0032188 A1
(43) Pub. Date: Jan. 29, 2026

(54) DISPLAY DEVICE AND MOBILE TERMINAL

(71) Applicant: Wuhan China Star Optoelectronics Semiconductor Display Technology Co., Ltd., Wuhan, Hubei (CN)

(72) Inventors: Zhifu LI, Wuhan, Hubei (CN); Wen HAN, Wuhan, Hubei (CN)

(21) Appl. No.: 18/995,412

(22) PCT Filed: Jun. 29, 2023
(86) PCT No.: PCT/CN2023/104049

§ 371 Date: Jan. 16, 2025

(30) Foreign Application Priority Data
Nov. 25, 2022 (CN) 202211493785.1

(51) Int. Cl. H04M 1/02; G06F 1/16

(52) U.S. Cl. CPC H04M 1/0295; G06F 1/1643; H04M 1/0269

(57) ABSTRACT

Display apparatuses (10, 20) and a mobile terminal. The display apparatuses (10, 20) comprise a middle frame (13) and display modules (11, 21) located in the middle frame (13). The display modules (11, 21) comprise a display panel (211) and a metal support member (212). The display panel (211) comprises a display portion (211A), a binding portion (211B) disposed opposite to the display portion (211A), and a first bending portion (211C) connected between the display portion (211A) and the binding portion (211B). The metal support member (212) is provided between the display portion (211A) and the binding portion (211B); wherein the side of the metal support member (212) furthest from the display portion (211A) is directly fixedly connected to the middle frame (13). The invention reduces the weight and thickness of the display modules (11, 21), achieving lighter, thinner display modules (11, 21).

### TECHNICAL FIELD

The present disclosure relates to the technical field of display, and in particular, to a display device and a mobile terminal.

### BACKGROUND

At present, electronic devices such as mobile phones, tablets, and computers have become inseparable from our lives, are everywhere in our lives and can be seen everywhere in our lives, which greatly improves people's living standards. With the rapid development of communication equipment technology, consumers expect to obtain better mobile experience of lightness, thinness, and portability, and therefore, higher and higher demands are put forward on the lightness and thinness of the electronic devices.

Please refer to FIG. 1, which is an exploded view of an existing display device. In the prior art, when an existing display device 10 is assembled, an existing display module 11, a middle frame support plate 12, a middle frame 13, and a rear shell 14 are usually bonded in sequence. The middle frame support plate 12 is capable of supporting the existing display device module 11. However, in the structure design of the existing display device 10, the middle frame support plate 12 has a large thickness and a heavy weight, so that the existing display device 10 is not thin enough and has poor portability. Moreover, the structural space required for installing the middle frame support plate 12 is relatively large, which wastes the space design of the display device 10 and reduces the value addition of the display device 10.

### SUMMARY

Embodiments of the present disclosure provide a display module and a mobile terminal to alleviate deficiencies in the related art.

To realize the above functions, the technical solutions provided by the embodiments of the present disclosure are as follows:

Embodiments of the present disclosure provide a display device, which includes a middle frame and a display module disposed in the middle frame, wherein the display module includes:
a display panel, including a display portion, a binding portion disposed opposite to the display portion, and a first bending portion connected between the display portion and the binding portion; and
a metal support member disposed between the display portion and the binding portion;
wherein one side of the metal support member away from the display portion is directly and fixedly connected to the middle frame.

In the display device provided in the embodiment of the present disclosure, the metal support member has a single-layer structure, the metal support member includes a first side and a second side that are disposed opposite to each other, the first side of the metal support member is directly attached to a rear surface of the display portion, and the second side of the metal support member is directly and fixedly connected to the middle frame.

In the display device provided in the embodiment of the present disclosure, the metal support member includes a first frame portion and a second frame portion, an orthographic projection of the first frame portion on the middle frame does not overlap with an orthographic projection of the binding portion on the middle frame, and an orthographic projection of the second frame portion on the middle frame overlaps with an orthographic projection of the binding portion on the middle frame; and
wherein the display module further includes a connector disposed between the metal support member and the middle frame, and the first frame portion of the metal support member is directly and fixedly connected to the middle frame through the connector.

In the display device provided in the embodiments of the present disclosure, a material of the metal support member is one of an aluminum alloy, a stainless steel, an injection-molded copper sheet, a copper column, or a thermoplastic polymer structural material.

In the display device provided in the embodiments of the present disclosure, a thickness of the metal support member is greater than or equal to 0.2 mm and less than or equal to 2 mm.

In the display device provided in the embodiments of the present disclosure, the display module includes a connecting component disposed between the metal support member and the binding portion; and
wherein a first side of the metal support member is in direct contact with the display portion, and a second side of the metal support member is connected to the binding portion through the connecting component.

In the display device provided in the embodiments of the present disclosure, a groove is provided on the second side of the metal support member, and the groove is provided at one end of the metal support member close to the first bending portion; and wherein the connecting component is disposed in the groove.

In the display device provided in the embodiments of the present disclosure, the metal support member includes a first support sub-member and a second support sub-member, the second support sub-member is disposed corresponding to the groove, and a thickness of the first support sub-member is greater than a thickness of the second support sub-member in a direction of a light emitting side of the display portion; and
wherein an orthographic projection of the second support sub-member on the binding portion completely covers an orthographic projection of the connecting component on the binding portion, and the orthographic projection of the connecting component on the metal support member overlaps with the orthographic projection of the binding portion on the metal support member.

In the display device provided in the embodiments of the present disclosure, an orthographic projection of the first support sub-member on the display portion covers a orthographic projection of the connector on the display portion, and the orthographic projection of the second support sub-member on the display portion does not overlap with the orthographic projection of the connector on the display portion.

In the display device provided in the embodiments of the present disclosure, the display module includes a display area and a non-display area surrounding the display area, and the display module includes:
a touch layer disposed in the display area, and the touch layer is disposed on one side of the display portion away from the metal support member; and
a color filter layer disposed in the display area, the color filter layer is disposed on one side of the touch layer away from the display portion, and the color filter layer includes a plurality of color resists disposed at intervals and a black matrix disposed between adjacent color resists;
wherein at least part of the black matrix is disposed on one side of the display area close to the non-display area.

In the display device provided in the embodiments of the present disclosure, the non-display area includes an extension area adjacent to the display area, and the display module includes:
a cover plate disposed on one side of the color filter layer away from the display portion, and the cover plate includes a body portion disposed in the display area and an extension portion disposed in the extension area;
a shielding layer disposed in the extension area, and an orthographic projection of the shielding layer on the cover plate covers the extension portion, wherein the shielding layer is in contact with the black matrix.

Embodiment of the present disclosure provide a mobile terminal, which includes terminal body and a display device. The terminal body and the display device are integrated into one body. The display device includes a middle frame and a display module disposed in the middle frame, wherein the display module includes:
a display panel, including a display portion, a binding portion disposed opposite to the display portion, and a first bending portion connected between the display portion and the binding portion; and
a metal support member disposed between the display portion and the binding portion;
wherein one side of the metal support member away from the display portion is directly and fixedly connected to the middle frame.

In the mobile terminal provided in the embodiments of the present disclosure, the metal support member has a single-layer structure, the metal support member includes a first side and a second side that are disposed opposite to each other, the first side of the metal support member is directly attached to a rear surface of the display portion, and the second side of the metal support member is directly and fixedly connected to the middle frame.

In the mobile terminal provided in the embodiments of the present disclosure, the metal support member includes a first frame portion and a second frame portion, an orthographic projection of the first frame portion on the middle frame does not overlap with an orthographic projection of the binding portion on the middle frame, and an orthographic projection of the second frame portion on the middle frame overlaps with an orthographic projection of the binding portion on the middle frame; and
wherein the display module further includes a connector disposed between the metal support member and the middle frame, and the first frame portion of the metal support member is directly and fixedly connected to the middle frame through the connector.

In the mobile terminal provided in the embodiments of the present disclosure, a material of the metal support member is one of an aluminum alloy, a stainless steel, an injection-molded copper sheet, a copper column, or a thermoplastic polymer structural material.

In the mobile terminal provided in the embodiments of the present disclosure, a thickness of the metal support member is greater than or equal to 0.2 mm and less than or equal to 2 mm.

In the mobile terminal provided in the embodiments of the present disclosure, the display module includes a connecting component disposed between the metal support member and the binding portion; and
wherein a first side of the metal support member is in direct contact with the display portion, and a second side of the metal support member is connected to the binding portion through the connecting component.

In the mobile terminal provided in the embodiments of the present disclosure, a groove is provided on the second side of the metal support member, and the groove is provided at one end of the metal support member close to the first bending portion; and wherein the connecting component is disposed in the groove.

In the mobile terminal provided in the embodiments of the present disclosure, the metal support member includes a first support sub-member and a second support sub-member, the second support sub-member is disposed corresponding to the groove, and a thickness of the first support sub-member is greater than a thickness of the second support sub-member in a direction of a light emitting side of the display portion; and
wherein an orthographic projection of the second support sub-member on the binding portion completely covers an orthographic projection of the connecting component on the binding portion, and the orthographic projection of the connecting component on the metal support member overlaps with the orthographic projection of the binding portion on the metal support member.

In the mobile terminal provided in the embodiments of the present disclosure, an orthographic projection of the first support sub-member on the display portion covers a orthographic projection of the connector on the display portion, and the orthographic projection of the second support sub-member on the display portion does not overlap with the orthographic projection of the connector on the display portion.

### ADVANTAGEOUS EFFECTS

Embodiments of the present disclosure provide a display device and a mobile terminal. The display device includes a middle frame and a display module disposed in the middle frame. The display module includes a display panel and a metal support member. The display panel includes a display portion, a binding portion disposed opposite to the display portion, and a first bending portion connected between the display portion and the binding portion. The metal support member is disposed between the display portion and the binding portion. One side of the metal support member away from the display portion is directly and fixedly connected to the middle frame. In this way, the weight and thickness of the display module are reduced, so as to achieve the purpose of lightening and thinning the display module.

### DESCRIPTION OF THE DRAWINGS

The technical solutions and other beneficial effects of the present disclosure will be apparent from the detailed description of specific embodiments of the present disclosure with reference to the accompanying drawings.

FIG. 1 is an exploded view of an existing display device;

FIG. 2 is a schematic structural diagram of an existing display module;

FIG. 3 is an exploded view of a display device according to embodiments of the present disclosure;

FIG. 4 is a schematic diagram of a display module in a first configuration according to embodiments of the present disclosure;

FIG. 5 is a top view of a metal support member according to embodiments of the present disclosure; and

FIG. 6 is a schematic diagram of a display module in a second configuration according to embodiments of the present disclosure.

### DETAILED DESCRIPTION

Hereinafter, technical solutions in embodiments of the present disclosure will be clearly and completely described with reference to the accompanying drawings in embodiments of the present disclosure. Apparently, the described embodiments comprise but are not limited to the embodiments of the present disclosure. Other embodiments that can be obtained by a person with ordinary skill in the art on the basis of the embodiments in the present disclosure without creative labor belong to the protection scope of the present disclosure.

Embodiments of the present disclosure provide a display device and a mobile terminal, which are described in detail as follows. It should be noted that the description order of the following embodiments is not intended to limit the preferred order of the embodiments.

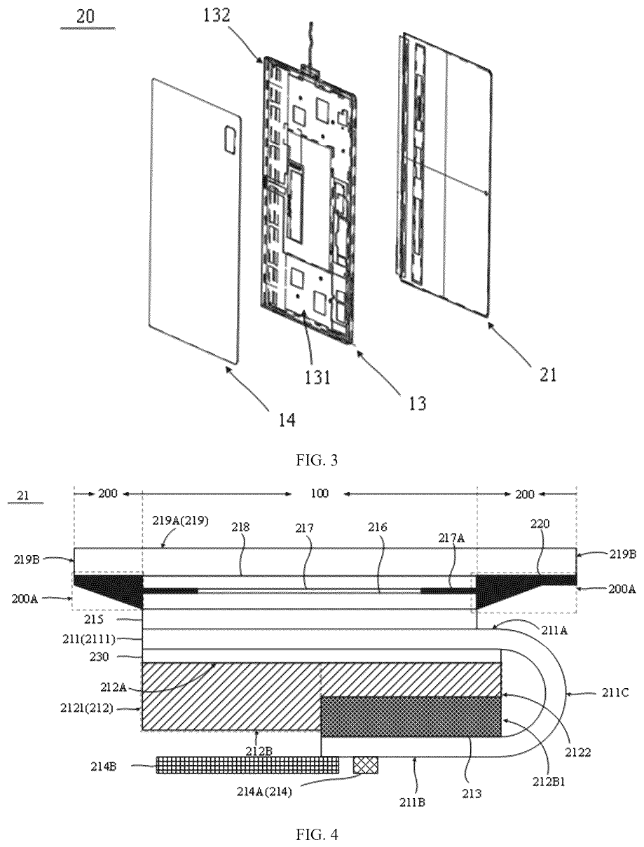

Referring to FIGS. 3 to 6, embodiments of the present disclosure provide a display device and a mobile terminal. The display device includes a middle frame 13 and a display module 21 disposed in the middle frame 13. The display module 21 includes a display panel 211 and a metal support member 212. The display panel 211 includes a display portion 211A, a binding portion 211B disposed opposite to the display portion 211A, and a first bending portion 211C connected between the display portion 211A and the binding portion 211B. The metal support member 212 is disposed between the display portion 211A and the binding portion 211B. One side of the metal support member 212 away from the display portion 211A is directly and fixedly connected to the middle frame 13.

It can be understood that in the embodiments of the present disclosure, a metal support member is disposed between the display portion and the binding portion, and one side of the metal support member away from the display portion is directly and fixedly connected to the middle frame, thereby reducing the weight and thickness of the display module and realizing the lightness and thinning of the display module.

The technical solutions of the present disclosure will now be described in connection with specific embodiments.

### Embodiment 1

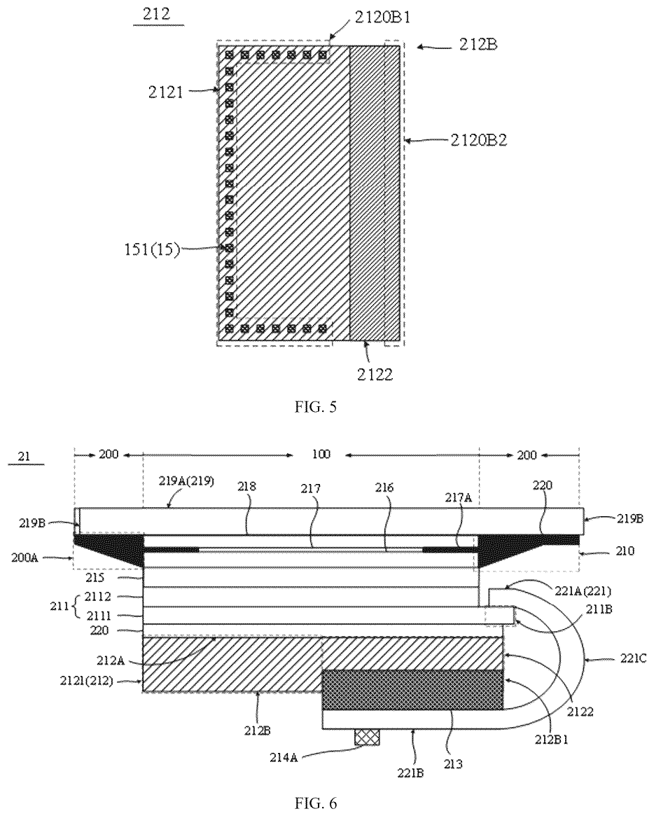

Please refer to FIG. 3, FIG. 4, and FIG. 5. FIG. 3 is an exploded view of a display device according to embodiments of the present disclosure. FIG. 4 is a schematic diagram of a display module in a first configuration according to embodiments of the present disclosure. FIG. 5 is a top view of a metal support member according to embodiments of the present disclosure.

In this embodiment, a display device 20 is provided. The display device 20 includes a display module 21 in a middle frame 13. The display module 21 includes a display panel 211 and a metal support member 212. The display panel 211 includes a display portion 211A, a binding portion 211B disposed opposite to the display portion 211A, and a first bending portion 211C connected between the display portion 211A and the binding portion 211B. The metal support member 212 is disposed between the display portion 211A and the binding portion 211B. One side of the metal support member 212 away from the display portion 211A is directly and fixedly connected to the middle frame 13.

It should be noted that the display panel 211 may be one of a liquid crystal display panel or an active light emitting display panel, for example, an organic light emitting diode (OLED) display panel, an active matrix organic light emitting diode (AMOLED) display panel, a passive matrix OLED display panel, and a quantum dot light emitting Diode (QLED) display panel. In this embodiment, an organic light emitting diode display panel is used as an example to describe the technical solutions of the present disclosure.

Further, the metal support member 212 has a single-layer structure. The metal support member 212 includes a first side 212A and a second side 212B that are disposed opposite to each other. The first side 212A of the metal support member 212 is directly attached to a rear surface of the display panel 211, and the second side 212B of the metal support member 212 is directly and fixedly connected to the middle frame 13. It can be understood that in this embodiment, by setting the metal support member 212 as a single-layer structure, directly attaching the first side 212A of the metal support member 212 to a rear surface of the display portion 211A, and directly and fixedly connecting the second side 212B of the metal support member 212 to the middle frame 13, the metal support member 212 and the display panel 211 are integrated into one body, thereby reducing the weight and thickness of the display module 21, so as to achieve the purpose of lightening and thinning the display module.

Further, the metal support member 212 includes a first frame portion 2120B1 and a second frame portion 2120B2. The orthographic projection of the first frame portion 2120B1 on the middle frame 13 does not overlap with the orthographic projection of the binding portion 211B on the middle frame 13, and the orthographic projection of the second frame portion 2120B2 on the middle frame 13 overlaps with the orthographic projection of the binding portion 211B on the middle frame 13. The display module 21 further includes a connector 15 disposed between the metal support member 212 and the middle frame 13, and the first frame portion 2120B1 of the metal support member 212 is directly and fixedly connected to the middle frame 13 through the connector 15.

Specifically, the middle frame 13 includes a bottom frame 131 and a side frame 132. The side frame 132 is connected to an outer periphery of the bottom frame 131. The first frame portion 2120B1 of the metal support member 212 is directly and fixedly connected to the bottom frame 131 through the connector 15. It can be understood that, compared with the existing display device 10, the display module includes a cover plate 219 and a display panel 211. The cover plate 219 is usually connected to the middle frame 13 by viscous adhesive (not shown in the figures). In this embodiment, the first frame portion 2120B1 of the metal support member 212 is directly and fixedly connected to the bottom frame 131 through the connector 15, so that the connection between the metal support member 212 and the bottom frame 131 is enhanced.

Further, the connector 15 includes a plurality of first sub-connectors 151 disposed on the first frame portion 2120B1 of the metal support member 212 and a plurality of second sub-connectors (not shown in the figures) disposed on the bottom frame 131, wherein one of the plurality of first sub-connectors 151 corresponds to one of the plurality of second sub-connectors, and the plurality of first sub-connectors 151 and the plurality of second sub-connectors are connected to each other, so as to realize direct fixed connection between the metal support member 212 and the bottom frame 131. The first connector 151 is preferably a screw hole, and the second connector 151 is preferably a nut. It can be understood that, in another embodiment, the first sub-connector 151 includes aconcave structure with a slot, and the second sub-connector includes a convex structure with a shape matching with the slot.

It can be understood that, in the existing display device 10, the display module 11 is generally connected to the middle frame 13 by viscous adhesive, wherein when the temperature of the existing display device 10 rises, the viscous adhesive has an adhesive failure, thereby causing the display module 11 to have a risk of falling off from the middle frame 13. In this embodiment, the connector 15 includes a plurality of first sub-connectors 151 disposed on the metal supporting member 212 and a plurality of second sub-connectors disposed on the bottom frame 131, one of the plurality of first sub-connectors 151 corresponds to one of the plurality of second sub-connectors, and the plurality of first sub-connectors 151 and the plurality of second sub-connectors are matched with each other to realize direct fixed connection between the metal support member 212 and the bottom frame 131, wherein the first connector 151 is preferably a screw hole, and the second connector 151 is preferably a nut. In this way, the connector 15 can be prevented from losing its viscosity due to the influence of high temperature.

In this embodiment, the material of the metal support member 212 includes but is not limited to a metal material or a plastic material. The material of the metal support member 212 is one of an aluminum alloy, a stainless steel (SUS), an injection-molded copper sheet, a copper column, or a thermoplastic polymer structural material (ABS). When the material of the metal support member 212 is a metal material, it has strong supporting performance and good heat conduction effect, thereby dissipating the heat generated by the display panel 211.

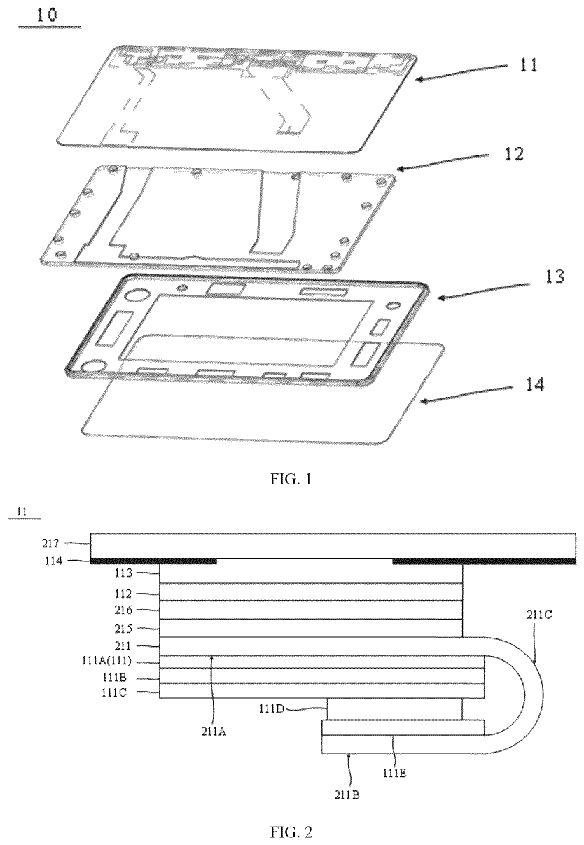

Referring to FIG. 1, FIG. 2, FIG. 3, and FIG. 4. FIG. 2 is a schematic structural diagram of an existing display module. In the structure design of the existing display device 10, the existing display module 11, the middle frame support plate 12, the middle frame 13 and the rear shell 14 are usually bonded in sequence. The existing display module 11 includes a display panel 211 and a support member 111. The support member 111 is disposed on a rear surface of the display panel 211. The display panel 211 includes a display portion 211A, a binding portion 211B disposed opposite to each other, and a first bending portion 211C connected between the display portion 211A and the binding portion 211B. The support member 111 includes a first back panel 111A, a heat dissipation layer 111B, a shielding layer 111C, a jointing element 111D and a second back panel 111E disposed between the display portion 211A and the binding portion 211B. It can be understood that the existing display device 10 includes the support member 111 for fixing and supporting the display panel 211, and the middle frame support plate 12 for supporting the display module 11, as a result, the overall thickness of the existing display device 10 is relatively large, the portability is poor, and it cannot meet the technical requirements of the light and thin structure of modern electronic equipment. In this embodiment, a metal support member 212 is disposed between the display panel 211 and the middle frame 13, and the metal support member 212 has a single-layer structure. The metal support member 212 includes a first side 212A and a second side 212B that are disposed opposite to each other. The first side 212A of the metal support member 212 is directly attached to a rear surface of the display panel 211, and the second side 212B of the metal support member 212 is directly and fixedly connected to the middle frame 13. As a resuly, the metal support member 212 and the display panel 211 are integrated into one body, thereby reducing the weight of the display module 21 and achieving lightness and thinness of the display module 21.

In this embodiment, the display panel 211 includes an insulating substrate 2111, which may be a flexible substrate. Specifically, when the insulating substrate 2111 is a flexible substrate, a material of the insulating substrate 2111 may include at least one of acrylic resin, methacrylic resin, polyisoprene, vinyl-based resin, epoxy-based resin, urethane-based resin, cellulosic resin, siloxane resin, polyimide-based resin, and polyamide-based resin. It can be understood that, in this embodiment, the technical solutions of the present disclosure is described by taking the insulating substrate 2111 as a flexible substrate as an example.

Further, in this embodiment, the display portion 211A, the first bending portion 211C, and the binding portion 211B are integrally formed. The display module 21 further includes a connecting component 213 disposed between the metal support member 212 and the binding portion 211B. The first side 212A of the metal support member 212 is in direct contact with the display portion 211A, and the second side 212B of the metal support member 212 is connected to the binding portion 211B through the connecting component 213.

Specifically, in this embodiment, a groove 212B1 is provided on the second side 212B of the metal support member 212, and the groove 212B1 is provided at one end of the metal support member 212 close to the first bending portion 211C. The connecting component 213 is disposed in the groove 212B1. It can be understood that, in this embodiment, by disposing the connecting component 213 in the groove 212B1, the combined thickness of the metal support member 212 and the connecting component 213 is reduced, thereby reducing the bending radius of the first bending portion 211C and improving the bending performance.

Further, in this embodiment, the metal support member 212 includes a first support sub-member 2121 and a second support sub-member 2122. The second support sub-member 2122 is disposed corresponding to the groove 212B1. The thickness of the first support sub-member 2121 is greater than a thickness of the second support sub-member 2122 in a direction of a light emitting side of the display panel 211. The orthographic projection of the second support sub-member 2122 on the binding portion 211B completely covers the orthographic projection of the connecting component 213 on the binding portion 211B, and the orthographic projection of the connecting component 213 on the metal support member 212 overlaps with the orthographic projection of the binding portion 211B on the metal support member 212.

It should be noted that, in this embodiment, the orthographic projection of the second support sub-member 2122 on the binding portion 211B may overlap with the orthographic projection of the connecting component 213 on the binding portion 211B, or the orthographic projection of the second support sub-member 2122 on the binding portion 211B may cover the orthographic projection of the connecting component 213 on the binding portion 211B.

In this embodiment, the orthographic projection of the metal support member 212 covers the orthographic projection of the display portion 211A, the orthographic projection of the first support sub-member 2121 on the display portion 211A covers the orthographic projection of the connector 15 on the display portion 211A, and the orthographic projection of the second support sub-member 2122 on the display portion 211A does not overlap with the orthographic projection of the connector 15 on the display portion 211A. It can be understood that, in this embodiment, since the orthographic projection of the second support sub-member 2122 on the display portion 211A does not overlap with the orthographic projection of the connector 15 on the display portion 211A, the connector 15 is prevented from affecting the circuit of the binding portion 211B and damaging the performance of the display module 21.

It should be noted that, in this embodiment, the connecting component 213 is connected to one side of the first support sub-member 2121 close to the first bending portion 211C, thereby reducing the bending radius of the first bending portion 211C and improving the bending performance. Further, the metal support member 212 is connected to the display portion 211A through a pressure-sensitive adhesive (PSA) 230, thereby reducing the press deformation variable of the metal support member 212 against the film layer of the display panel 211, and reducing the imprint of the display panel 211 during the process of bending and attaching of the film layers.

In this embodiment, the display module 21 further includes a binding element 214 disposed on the side of the binding portion 211B away from the display portion 211A. The binding element 214 includes a chip-on-film (not shown in the figures), a driving chip 214A, and a circuit board 214B. The bottom frame 131 is provided with a plurality of slots (not marked in the figures), and the slots are provided corresponding to the binding element 214. The driving chip 214A is located in the slots, and the circuit board 214B is located in the slots. In this way, the bottom frame 131 is prevented from damaging the driving chip 214A and the circuit board 214B, thereby damaging the performance of the display module 21.

In this embodiment, the display module 21 includes a display area 100 and a non-display area 200 surrounding the display area 100. The display module 21 includes a touch layer 216 and a color filter layer 217. The touch layer 216 is disposed in the display area 100, the touch layer 216 is disposed on one side of the display portion 211A away from the metal support member 212. The color filter layer 217 is disposed in the display area 100. The color filter layer 217 is disposed on one side of the touch layer 216 away from the display portion 211A. The color filter layer 217 includes a plurality of color resists (not shown in the figures) disposed at intervals and a black matrix 217A disposed between adjacent color resists. At least part of the black matrix 217A is disposed on one side of the display area 100 close to the non-display area 200.

It can be understood that, referring to FIGS. 2, 3, and 4, in the structural design of the existing display module 11, the existing display module 11 further includes an encapsulation layer 215, a touch layer 216, a polarizer 112 and an adhesive layer 113 located on the side of the display panel 211 away from the support member, and the thickness of the polarizer 112 is large (usually 104 microns). As a result, the overall thickness of the existing display module 11 is relatively large, which cannot meet the technical requirements of the light and thin structure of modern electronic equipment. It can be understood that, in this embodiment, since the color filter layer 217 is disposed on the side of the touch layer 216 away from the display panel 211, the polarizer 112 in the existing display module 11 can be removed without affecting the display effect of the display panel 211. Meanwhile, the thickness of the display module 21 is reduced, thereby achieving the purpose of lightening and thinning the display module 21.

Further, in this embodiment, the non-display area 200 includes an extension area 200A adjacent to the display area 100. The display module 21 further includes an adhesive layer 218, a cover plate 219, and a shielding layer 220. The cover plate 219 is located on one side of the color filter layer 217 away from the display portion 211A. The cover plate 219 includes a body portion 219A disposed in the display area and an extension portion 219B disposed in the extension area 200A. The shielding layer 220 is disposed in the extension area 200A. The orthographic projection of the shielding layer 220 on the cover plate 219 covers the extension portion 219B. The shielding layer 220 is in contact with the black matrix 217A.

It should be noted that the material of the shielding layer 220 is preferably black adhesive, the adhesive layer 218 is located between the color filter layer 217 and the cover plate 219, the color filter layer 217 is bonded to the cover plate 219 through the adhesive layer 218, and the material of the adhesive layer 218 is preferably optical adhesive.

It can be understood that, in the existing display module 11, a layer of ink 114 is generally disposed on the side of the cover plate 219 close to the display panel 211 to prevent light leakage from occurring at the edge of the display panel 211. However, due to the large thickness of the ink 114, bubbles are easily generated when it is attached to the cover plate 219, and the adhesion uniformity is not ideal, which greatly reducing the appearance quality of the display module 11. In this embodiment, the shielding layer 220 may be formed in the extension area 200A by adopting a dispensing process, and the shielding layer 220 is preferably made of black adhesive, so that the generation of bubbles can be avoided, and the adhesion is uniform, thereby improving the appearance quality of the display module 21. Further, in this embodiment, the shielding layer 220 is disposed in the extension area 200A, and the orthographic projection of the extension portion 219B on the cover plate 219 covers the extension portion 219B, thereby preventing light leakage from the edge of the display portion 211A of the display panel 211, and improving the display effect of the display device 20.

It should be noted that, in this embodiment, the cover plate 219 may be selected from any one of cover-glass (CG) cover plate or 3D cover plate 219, which is not specifically limited in this embodiment. In an embodiment, when the cover plate 219 is a 3D cover plate, the cover plate 219 includes a flat area and a cover plate bending area located on at least one side of the flat rarea, and the cover plate bending area is smoothly connected to the flat area. The inner side of the cover plate 219 is used for accommodating the display module 21. At this time, the display portion 211A may include a flat display portion and an arc surface display portion connected between the flat display portion and the first bending portion 211C, and the cover plate bending area is disposed corresponding to the arc surface display portion.

Further, the display device 20 further includes a rear shell 14 located on the side of the middle frame 13 away from the display module 21, and a battery assembly (not shown in the figures) located between the middle frame 13 and the rear shell 14. It can be understood that, in the existing display device 10, the thickness of the middle frame support plate 12 is relatively large, so it is liable to cause the problem that the space of the battery assembly is insufficient, which further affects the runtime of the display device 20. It can be understood that, compared with the existing display device 10, in this embodiment, a metal support member 212 is provided on the rear surface of the display panel 211. The first side 212A of the metal support member 212 is connected to the display panel 211, and the second side 212B of the metal support member 212 is fixedly connected to the middle frame 13. Further, the thickness of the metal support member 212 is greater than or equal to 0.2 mm and less than or equal to 10 mm, preferably the thickness of the metal support member 212 is greater than or equal to 0.2 mm and less than or equal to 2 mm. In this way, the problem that the middle frame support plate 12 occupies a large space and the battery assembly has insufficient space in the existing display device 10 is alleviated.

### Embodiment 2

Referring to FIG. 6, which is a schematic diagram of a display module in a second configuration according to embodiments of the present disclosure.

The structure of the display module in this embodiment is similar to/the same as the first structure of the display module provided in the above-described embodiment. For details, please refer to the description of the display module in the above-described embodiment, which will not be repeated herein. The differences between the two lies in that:

In this embodiment, the display panel 211 includes an insulating substrate 2111 and a display functional layer 2112 disposed on the insulating substrate 2111. The insulating substrate 2111 can be a rigid substrate. Specifically, when the insulating substrate 2111 is a rigid substrate, the material of the insulating substrate 2111 may include metals or glasses. In this embodiment, the technical solutions of the present disclosure is described by taking the insulating substrate 2111 as a rigid substrate as an example.

In this embodiment, the display device 20 further includes a flexible printed circuit 221 (FPC) and a driving chip 214A. The flexible printed circuit 221 includes a first connecting portion 221A located on one side of the display panel 211 away from the metal support member 212, a second connecting portion 221B located on one side of the metal support member 212 away from the display panel 211, and a second bending portion 221C connected between the first connecting portion 221A and the second connecting portion 221B. The first connecting portion 221A, the second bending portion 221C, and the second connecting portion 221B are integrally formed. The first support sub-member 2121 is fixedly connected to the bottom frame 131 through the connector 15, the second support sub-member 2122 is connected to the second connecting portion 221B through the connector 213, and the driving chip 214A is located on one side of the second connecting portion 221B away from the display panel 211.

Further, in this embodiment, the display panel 211 includes a binding portion 211B located in the non-display area 200. The first connecting portion 221A is located on one side of the binding portion 211B away from the metal support member 212. The binding portion 211B is connected to the first connecting portion 221A.

In this embodiment, a mobile terminal is provided, which includes a terminal body and the display device described in any one of the above embodiments, wherein the terminal body is integrated with the display device into one body.

It can be understood that the display module has been described in detail in the above embodiments, which will not be repeated herein.

In specific applications, the mobile terminal may be a display screen of an apparatus, such as a smart mobile phone, a tablet computer, a notebook computer, a smart wristband, a smart watch, smart glasses, a smart helmet, a desktop computer, a smart television or a digital camera, or even may be applied to an electronic apparatus having a flexible display screen.

The present disclosure has been described with preferred embodiments thereof. The above preferred embodiments are not intended to limit the present disclosure, and it is understood that many changes and modifications to the described embodiments can be carried out without departing from the scope and the spirit of the disclosure that is intended to be limited only by the appended claims.

What is claimed is:

1. A display device, comprising a middle frame and a display module disposed in the middle frame, wherein the display module comprises:
a display panel, comprising a display portion, a binding portion disposed opposite to the display portion, and a first bending portion connected between the display portion and the binding portion; and
a metal support member disposed between the display portion and the binding portion;
wherein one side of the metal support member away from the display portion is directly and fixedly connected to the middle frame.

2. The display device according to claim 1, wherein the metal support member has a single-layer structure, the metal support member comprises a first side and a second side that are disposed opposite to each other, the first side of the metal support member is directly attached to a rear surface of the display portion, and the second side of the metal support member is directly and fixedly connected to the middle frame.

3. The display device according to claim 2, wherein the metal support member comprises a first frame portion and a second frame portion, an orthographic projection of the first frame portion on the middle frame does not overlap with an orthographic projection of the binding portion on the middle frame, and an orthographic projection of the second frame portion on the middle frame overlaps with an orthographic projection of the binding portion on the middle frame; and
wherein the display module further comprises a connector disposed between the metal support member and the middle frame, and the first frame portion of the metal support member is directly and fixedly connected to the middle frame through the connector.

4. The display device according to claim 2, wherein a material of the metal support member is one of an aluminum alloy, a stainless steel, an injection-molded copper sheet, a copper column, or a thermoplastic polymer structural material.

5. The display device according to claim 2, wherein a thickness of the metal support member is greater than or equal to 0.2 mm and less than or equal to 2 mm.

6. The display device according to claim 3, wherein the display module comprises a connecting component disposed between the metal support member and the binding portion; and
wherein a first side of the metal support member is in direct contact with the display portion, and a second side of the metal support member is connected to the binding portion through the connecting component.

7. The display device according to claim 6, wherein a groove is provided on the second side of the metal support member, and the groove is provided at one end of the metal support member close to the first bending portion; and wherein the connecting component is disposed in the groove.

8. The display device according to claim 7, wherein the metal support member comprises a first support sub-member and a second support sub-member, the second support sub-member is disposed corresponding to the groove, and a thickness of the first support sub-member is greater than a thickness of the second support sub-member in a direction of a light emitting side of the display portion; and
wherein an orthographic projection of the second support sub-member on the binding portion completely covers an orthographic projection of the connecting component on the binding portion, and the orthographic projection of the connecting component on the metal support member overlaps with the orthographic projection of the binding portion on the metal support member.

9. The display device according to claim 8, wherein an orthographic projection of the first support sub-member on the display portion covers a orthographic projection of the connector on the display portion, and the orthographic projection of the second support sub-member on the display portion does not overlap with the orthographic projection of the connector on the display portion.

10. The display device according to claim 1, wherein the display module comprises a display area and a non-display area surrounding the display area, and the display module comprises:
a touch layer disposed in the display area, and the touch layer is disposed on one side of the display portion away from the metal support member; and
a color filter layer disposed in the display area, the color filter layer is disposed on one side of the touch layer away from the display portion, and the color filter layer comprises a plurality of color resists disposed at intervals and a black matrix disposed between adjacent color resists;
wherein at least part of the black matrix is disposed on one side of the display area close to the non-display area.

11. The display device according to claim 10, wherein the non-display area comprises an extension area adjacent to the display area, and the display module comprises:
a cover plate disposed on one side of the color filter layer away from the display portion, and the cover plate comprises a body portion disposed in the display area and an extension portion disposed in the extension area;
a shielding layer disposed in the extension area, and an orthographic projection of the shielding layer on the cover plate covers the extension portion, wherein the shielding layer is in contact with the black matrix.

12. A mobile terminal, wherein the mobile terminal comprises a terminal body and a display device, the terminal body and the display device are integrated into one body, the display device comprises a middle frame and a display module disposed in the middle frame, wherein the display module comprises:
a display panel, comprising a display portion, a binding portion disposed opposite to the display portion, and a first bending portion connected between the display portion and the binding portion; and
a metal support member disposed between the display portion and the binding portion;
wherein one side of the metal support member away from the display portion is directly and fixedly connected to the middle frame.

13. The mobile terminal according to claim 12, wherein the metal support member has a single-layer structure, the metal support member comprises a first side and a second side that are disposed opposite to each other, the first side of the metal support member is directly attached to a rear surface of the display portion, and the second side of the metal support member is directly and fixedly connected to the middle frame.

14. The mobile terminal according to claim 13, wherein the metal support member comprises a first frame portion and a second frame portion, an orthographic projection of the first frame portion on the middle frame does not overlap with an orthographic projection of the binding portion on the middle frame, and an orthographic projection of the second frame portion on the middle frame overlaps with an orthographic projection of the binding portion on the middle frame; and
wherein the display module further comprises a connector disposed between the metal support member and the middle frame, and the first frame portion of the metal support member is directly and fixedly connected to the middle frame through the connector.

15. The mobile terminal according to claim 13, wherein a material of the metal support member is one of an aluminum alloy, a stainless steel, an injection-molded copper sheet, a copper column, or a thermoplastic polymer structural material.

16. The mobile terminal according to claim 13, wherein a thickness of the metal support member is greater than or equal to 0.2 mm and less than or equal to 2 mm.

17. The mobile terminal according to claim 14, wherein the display module comprises a connecting component disposed between the metal support member and the binding portion; and
wherein a first side of the metal support member is in direct contact with the display portion, and a second side of the metal support member is connected to the binding portion through the connecting component.

18. The mobile terminal according to claim 17, wherein a groove is provided on the second side of the metal support member, and the groove is provided at one end of the metal support member close to the first bending portion; and wherein the connecting component is disposed in the groove.

19. The mobile terminal according to claim 18, wherein the metal support member comprises a first support sub-member and a second support sub-member, the second support sub-member is disposed corresponding to the groove, and a thickness of the first support sub-member is greater than a thickness of the second support sub-member in a direction of a light emitting side of the display portion; and
wherein an orthographic projection of the second support sub-member on the binding portion completely covers an orthographic projection of the connecting component on the binding portion, and the orthographic projection of the connecting component on the metal support member overlaps with the orthographic projection of the binding portion on the metal support member.

20. The mobile terminal according to claim 19, wherein an orthographic projection of the first support sub-member on the display portion covers a orthographic projection of the connector on the display portion, and the orthographic projection of the second support sub-member on the display portion does not overlap with the orthographic projection of the connector on the display portion.
